(19) United States
(12) Patent Application Publication
(10) Pub. No.: US 2008/0250430 A1
(43) Pub. Date: Oct. 9, 2008

(54) METHOD AND CORRESPONDING APPARATUS FOR CREATION OF PRINT DRIVERS IN A NETWORK

(75) Inventors: David Salgado, Victor, NY (US); Jonathan Allan Edmonds, Silverton, OR (US); Matthew Fabrizi, Penfield, NY (US); Gregory Fruin, Webster, NY (US); Alan K. Robertson, Rochester, NY (US); Raymond Sabbagh, Harbor City, CA (US); Richard Schwartz, Portland, OR (US); Glenn K. Smith, Webster, NY (US)

Correspondence Address: Prass & Irving, 2661 Riva Road, Building 1000, Suite 1044, Annapolis, MD, 21401, US

(73) Assignee: Xerox Corporation, Norwalk, CT (US)

(21) Appl. No.: 12/027,556

(22) Filed: Feb. 7, 2008

Related U.S. Application Data
(60) Provisional application No. 60/900,032, filed on Feb. 7, 2007.

(30) Foreign Application Priority Data
Feb. 7, 2007 (US) 60900032

(51) Int. Cl. G06F 9/54

(52) U.S. Cl. 719/327

(57) ABSTRACT

Disclosed are methods of creating drivers for use in a network, the network including computers and devices, and corresponding apparatus and computer-readable medium. The methods include providing a platform, the platform including: 1) a plurality of selectable communication components, each communication component relating to a type of network communication associated with a type of device; 2) a plurality of selectable PDL components, each PDL component relating to a type of PDL associated with a type of device; 3) a user interface component, the user interface component having plurality of selectable user interface elements; 4) a plurality of selectable workflow components, each workflow component relating to a type of workflow to be associated with a device; and 5) a plurality of selectable vertical feature components; determining a type of the device for which the driver is to be created, the device being on the network; and based on the determined type of the device, selecting and activating one of the communication components, one of the PDL components, the user interface component, and one of the workflow components, and instantiating each of the selected components, thereby creating a driver suitable for the determined type of device on the network.

This application claims priority from provisional application Ser. No. 60/900,032, filed Feb. 7, 2007.

### TECHNICAL FIELD

The present disclosure relates to network printing, in which a population of computers can send print jobs to a population of printers over a network.

### BACKGROUND

The concept of “network printing,” in which a set of digital printers or other machines, such as digital copiers or multifunction devices, are controlled using a network protocol, is well known. Heretofore, management of a network of printers, particularly at installation, has been a labor-intensive process. In order to set up a plurality of printers and make the printers accessible to a plurality of computers, a server on the network has to be configured, and this configuration process typically involves having a systems administrator, that is a person with the particular responsibility of maintaining the network, identify printers on the network, and configure drivers in order to access each of these printers. It would be desirable to provide a system in which a user could automatically obtain suitable drivers for printers of various types.

### SUMMARY

According to aspects of embodiments, there is provided methods of creating drivers for use in a network, the network including computers and devices, and corresponding apparatus and computer-readable medium. The methods include providing a platform, the platform including: 1) a plurality of selectable communication components, each communication component relating to a type of network communication associated with a type of device; 2) a plurality of selectable PDL components, each PDL component relating to a type of PDL associated with a type of device; 3) a user interface component, the user interface component having plurality of selectable user interface elements; 4) a plurality of selectable workflow components, each workflow component relating to a type of workflow to be associated with a device; and 5) a plurality of selectable vertical feature components; determining a type of the device for which the driver is to be created, the device being on the network; and based on the determined type of the device, selecting and activating one of the communication components, one of the PDL components, the user interface component, and one of the workflow components, and instantiating each of the selected components, thereby creating a driver suitable for the determined type of device on the network.

### BRIEF DESCRIPTION OF THE DRAWINGS

FIG. 1 shows components of a printer driver architecture.

FIG. 2 is an example diagram of how drivers can be in effect custom made by selecting components from a platform.

FIG. 3 is a diagram of a generalized feature component.

FIG. 4 is a user interface that would appear with a driver created using the platform of FIG. 1.

FIG. 5 is a user interface that would appear with a driver created using the platform of FIG. 1.

FIG. 6 is a diagram of a system for creating a driver.

FIG. 7 is a flowchart illustrating a method of creating a driver.

### DETAILED DESCRIPTION

A printer driver is an application that enables printing a document to a particular printing device (a device can be a printer or any machine, such as a copier or facsimile, having printing functions). The present disclosure describes an architecture and apparatus of a printer driver platform. This architecture consists of a set of inter-related components that enable the creation of a variety of different printer drivers over a large number of printing devices. In this way, by selecting components suitable for the physical functionality of a given type of device, and instantiating each of the selected components to be suitable for the device, a driver for the device is generated.

As used herein, the term “providing” shall simply mean “making available for use,” and does not necessarily imply any sale, conveyance, or business or customer relationship.

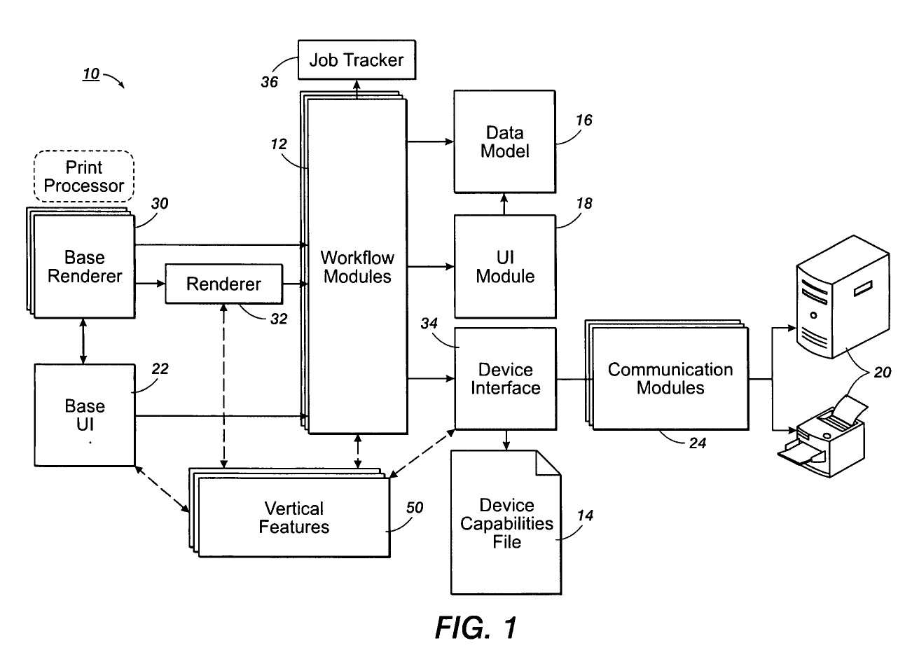

FIG. 1 shows the major components of a printer driver architecture, generally indicated as “platform” 10. Platform 10 may be used to create printer drivers as needed. The following is a description of the key components and several secondary components. Other possible components, not shown in the Figure, would be available in a practical implementation.

Workflow Modules 12 manages the instantiation and the control flow within the printer driver being created. The Workflow Modules 12 utilizes a plurality of different workflow components that are selectable based on a type of workflow to be associated with a device. The workflow components may include a Traditional Workflow component (used for a device and PDL specific printer driver), a Universal Workflow component (used for a printer driver that supports feature-rich printing to any device) and a Mobile Workflow component (used for a printer driver that finds available devices within the local network and supports basic printing functionality to these devices).

The Workflow Modules 12 employs Device Capabilities files 14 to populate the platform's Data Model 16 with the appropriate feature data for the particular device (printer) the driver is created for or connected to. A Device Capabilities file 14 describes the set of features and their options that the device supports. The Device Capabilities file 14 also includes the set of the device's inter-feature limitations (termed constraints). Depending on the particulars of the specific printer driver, the Workflow Modules 12 may obtain the Device Capabilities file from the device (examples of which are here shown as 20), from a network location (e.g. Web), or have it present in the printer driver package. The device 20 is illustrated in FIG. 1 as a printer connected to a computer. However, the device 20 may also be a stand-alone printer, connected to a network, where any computer connected to the network may have access to the printer, and thus have a need for a driver to drive the printer. The device 20 illustrated in FIG. 1 is one of a plurality of such printers and computers that are connected together in a network.

The Workflow Modules 12 controls the flow of information within the printer driver platform 10. In particular, when the printer driver is executing a print operation the Workflow Modules 12 creates a data flow pipe of the platform's components and manages the data flow from component to component in the production of the Page Description Language file sent to the printing device.

Data Model 16 manages the storage and manipulation of all of the printer driver's data. The data includes the device settings, feature capabilities, feature defaults, feature constraints, and saved settings. The data is stored in an internal data representation to optimize its storage and retrieval.

Data Model 16 contains a number of important sub-components (not shown individually). A Feature Dictionary is a data store of the present Printing Device's features and allowable values. A Constraint Engine manages and executes the feature constraints (as loaded from the Device Capability file). A Format Converter converts between the Data Module's internal data representation and another data format (e.g. Xerox Print Interchange Format, ASCII Job Ticket). An Observer Manager provides event switchboard capability. Platform components register for platform events that they need to be notified for. When an event occurs, a component within platform 10 notifies the Observer Manager of the event and the Observer Manager communicates the event to all registered components. The Observer Manager enables inter-component communication such that the individual components are isolated from other platform components.

User Interface Module 18 dynamically constructs the printer driver's user interface based on the functional capabilities of the target printing device (as defined in the Device Capabilities file). It creates a base user interface infrastructure of tabs and off-tab space upon which it adds feature's user interface specifics for a particular printer. The User Interface component employs a toolkit of well-defined UI controls (e.g. drop down boxes, text boxes, radio buttons and the like) and UI molecules (a combination of UI controls into a reusable unit such as a drop down box that supports text entry) that enable the ability to quickly create a wide variety of differing user interface presentations. Thus, the user interface created will vary depending on the features, options and constraints available in the Device Capabilities file 14.

The User Interface Module 18 also communicates to the Data Model 16 any UI selections made by a user. The Data Module executes the feature constraint based on the selection as well as communicating the user selection to registered components.

Rendering components 30 converts the print request's document information and objects (as communicated by the client operating system) into the specific PDL (page description language) objects and codes. Thus, the Rendering components 30 may include a plurality of rendering components of differing types for differing page description languages that may be used by a particular printer. The Rendering components may include a PostScript Renderer, a PCL5 renderer, and a PCL6 renderer, for example, corresponding to the most common types of page description languages in use. The appropriate rendering component 30 may then be selected based on the page description language used by the device 20. As shown, there is provided a base renderer 30, which is typically the renderer supplied with the operating system, and also a renderer component 32, that, when activated, can perform rendering functions in addition to those available to the base renderer 30.

Among other possible components in platform 10, a Print Processor (shown in dashed lines) enables pre-processing of the print data stream prior to the document's conversion into a PDL. The Print Processor may be necessary for the execution of some advanced functionality such as fit-to-new-size and fit-to-poster.

Device Interface 34 encapsulates all communication to the Printing Device 20 and provides interfaces to the other platform components to request specific Printing Device information and events. As such, platform clients of the Printing Device information do not need to know the details of the Printing Device or how the information is obtained from the Printing Device 20.

When information is acquired from the Printing Device 20, the Device Interface 34 updates the Data Model's 16 data store for the specific information. The Data Model 16, in turn, communicates the data change occurrence to all components registered for it. As mentioned previously, the use of the Data Model 16 as a communication intermediary enables clients of the information and the providers of the information to be fully independent of each other.

Communication Modules 24 manage all communication between the Platform 10 and the device 20. The Communication Modules 24 may include a plurality of types of communication components. Each of the types of communication components is used for a type of network communication that may be employed by a particular device. For example, devices may use network communication types such as SNMP (Simple Network Management Protocol), IPP (Internet Printing Protocol), and WSD (Web Services For Devices). By having a communication module for each of a variety of communication types, the platform may communicate with the device 20 no matter what type of communication type the device 20 may use.

Job Tracker 36 tracks a print job that has been submitted to a Printing Device. When the print job has completed its operation, the Job Tracker may display a notification to the user.

A Device Status and Printing Scout (not shown, but could be operatively associated with Device Interface 34) may present a printing device's dynamic state information to a user. The dynamic state information can include device error and warning messages, active job queue, completed job queue, and consumables state.

Also present in, or otherwise accessible to, the platform 10 is a set of Vertical Feature Components 50. A Vertical Feature component 50 is an encapsulation of a specific functional capability (e.g. watermarks, accounting, booklet making, facsimile, and the like). The printer driver platform contains a large number of vertical features that can be instantiated in printer driver user interface. A particular Vertical Feature component 50 is selected and activated only if it is desired and supported by a device 20. If a particular Vertical Feature component 50 is not selected for use in a driver, such as if the device does not have a booklet maker, no trace of the Vertical Feature will appear in, for example, in a UI associated with the driver.

As mentioned, a number of differing Workflow Module 12 instances exist; that is, the basic Workflow Module 12 can be instantiated in various ways to carry out a selected workflow. These Workflow Modules include (but are not limited to) a Traditional Workflow Module (for a device and PDL specific printer driver), a Universal Workflow Module (for a printer driver that support feature-rich printing to any device) and a Mobile Workflow Module (for a printer driver that finds available devices within the local network and supports basic printing functionality to these devices). With the Traditional Workflow module, the Workflow Module 12 is instantiated according to variables that make the Workflow Module operate in a manner suitable for a device of a known type: these variables are kept “on file” and are used as needed when a device of a certain type is installed on a network. With a Universal Workflow Module, the Workflow Module 12, either by itself or by activating other components, in effect performs a querying operation with a target device identified on the network: with this querying, the Workflow Module 12 finds out the proper settings for the device, such as what PDL is used, how many trays the device has, etc., and then is instantiated with variables suitable for operating the target device. A Mobile Workflow Module includes a capability for querying Internet addresses to identify a suitable device for printing; once a device is identified, the Workflow Module can then be instantiated to operate with the device.

When a specific printer driver is instantiated using the components in platform 10, the printer driver accesses a build script specifying the specific instances of the platform components to be used. For example, a Universal PCL6 Printer Driver will be built with the Universal Workflow Module, PCL6 Renderer, and all Vertical Components. Creating a different type of driver uses the Traditional Workflow Module, the PostScript Renderer, but would not include the Fax Vertical Component if the particular printer does not support fax. The platform components to be used are generally selected based on the Device Capabilities File 14.

The system generally shown in FIG. 1 allows the efficient production of printer drivers to support multiple devices and multiple workflows for a device. Since the architecture employs a collection of well-defined reusable components, it easily supports the creation of a new instantiation of a printer driver from the platform. This architecture helps reduce time-to-market and cost of creating printer drivers for a new printing device. In many cases, the addition of a new printing device primarily involves the creation of the Device Capability file and the driver's Build Script, which are in turn used to create a user interface for the print driver. The architecture enables easy extension of several components like Communication Services and Format Converters. Once the platform is extended with a new Vertical Feature, it is available for use in any printer drivers derived from the platform. Because of the three-tiered approach to features, the platform makes it cost-effective to produce one-off printer drivers to meet a customer's special request (e.g. a printer driver that only supports the secure print job type).

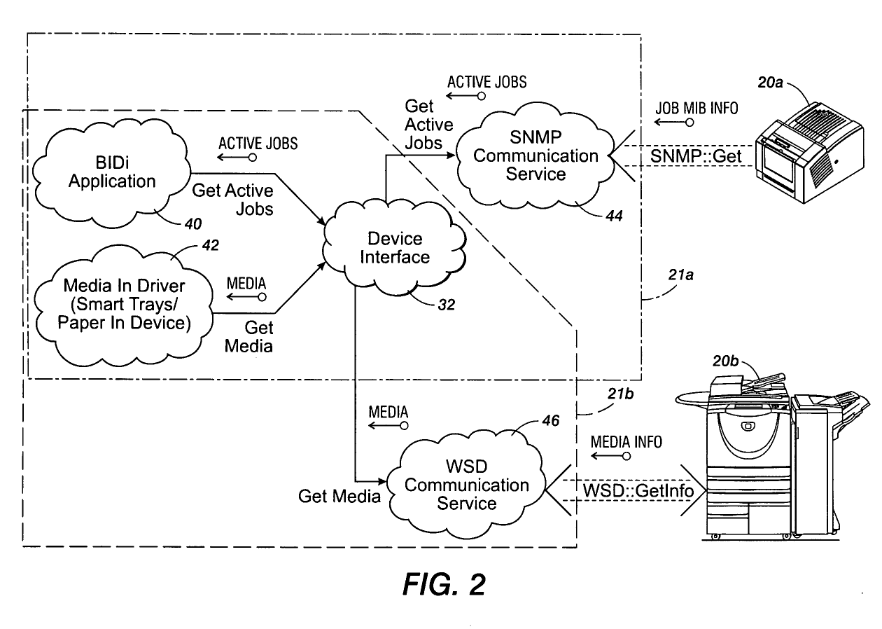

FIG. 2 is an example diagram of how drivers can be in effect custom made by selecting certain components from a platform such as platform 10 in FIG. 1 and instantiating the selected components in a particular way. A first device 20a is in this example a relatively low-featured, desktop printer controlled using SNMP: as shown device 20a is operated by a driver 21a that is resident on a user computer. Simultaneously, a second device 20b is a more featured digital copier that communicates with WSD, and is operated by a driver 21b on the same computer. The drivers 21a, 21b each include a set of activated, and suitably instantiated components (in addition to the components in the generalized platform shown in FIG. 1). In the FIG. 2 example, BiDi Application 40, Media In Driver 42, and Device Interface 34 (described above) are active and instantiated for both drivers 21a and 21b, although each component may be instantiated differently for each driver. Because device 20a uses SNMP for communications, its driver 21a includes an SNMP component 44; while, because device 20b uses WSD for communications, its driver 21a includes a WSD component 46.

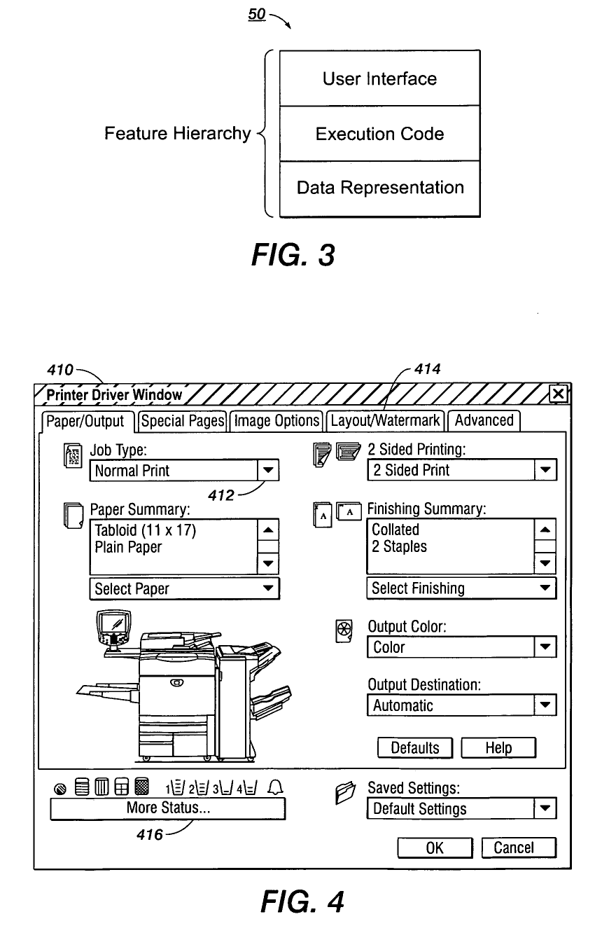

FIG. 3 is a diagram of a generalized feature component 50; this component could be any component in the Platform 10 as shown in FIG. 1 that is associated with a feature such as Vertical Features 50. As can be seen, the component 50 is written with a feature hierarchy in which code relating directly to a user interface for the feature rides on an execution code that largely carries out the function, such as creating a watermark or operating a booklet maker. The execution code in turn relies on a data representation that is an efficient means of representing the data needed for the presentation and execution of the feature.

The architecture of the feature components employs a clear separation between a feature's presentation (UI), a feature's data (representation of the feature), and the feature's execution (specific PDL emitted). This clean division enables the construction of differing printer drivers employing this platform architecture that varies the specifics of one feature layer without affecting the other two layers. For example, the Stapling feature has one UI presentation for smaller, less-featured A4 devices and a different presentation for highly featured devices (while the representation and execution of the stapling feature is the same). Some Vertical Features can conceptually be thought as multiple Vertical Features because one of the layers may vary greatly. For example, Booklet Vertical Feature can be considered conceptually two Vertical Features: a PostScript Booklet Vertical Feature and a PCL Booklet Vertical Feature. The PS and PCL Vertical Features use the same user interface and data but have very distinct execution code.

FIG. 4 is an example user interface window 410 that could appear with a print driver created using the platform of FIG. 1. Each pull-down menu 412 as shown in FIG. 4 communicates user options relating to a specific capability of the device. These options are generated by the build script associated with the device, which is generated from the device capabilities file 14, and, which causes activation of the components suitable for the device. The UI module 18 can also be designed to place certain features on tabs 414 (such as shown at the top of the window) and others in pull-down menus. The user interface itself (its look and feel) is manifest by the UI module 18 of the platform shown in FIG. 1: by using a common UI module 18, a common UI appearance is achieved for all devices accessed by the computer on which the driver resides.

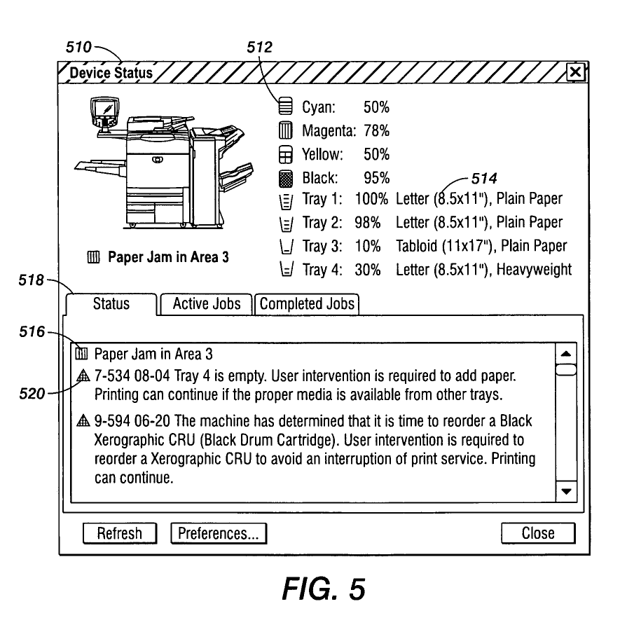

FIG. 5 is an example of the Device Status window 510 that shows the current state of a printer device. The window in FIG. 5, the look and feel of which is also created through UI module 18, provides a uniform display for messages coming from a device. The window may be accessed by a user by, for example, selecting the More Status item 416 in FIG. 4. Possible information conveyed may include information regarding paper trays 514, paper jams 516, toner levels 512, job status 518, problems with the printer 520, and the like.

In one possible business scenario using the platform-based architecture of FIG. 1, a vendor of devices retains the platform 10 and generates custom-made drivers of various kinds as each device is sold to a customer; in that case the customer receives the drivers and has generally only limited capability to alter the drivers, such as by changing some variables of the pre-selected components in each driver. In another possible business scenario, a typically large-enterprise customer obtains the basic platform, such as shown in FIG. 1, and is empowered to generate drivers for devices as needed; both in selecting and instantiating components. The scenario may be useful for large enterprises who wish to provide their own corporate identity in the look and feel of the driver UI's.

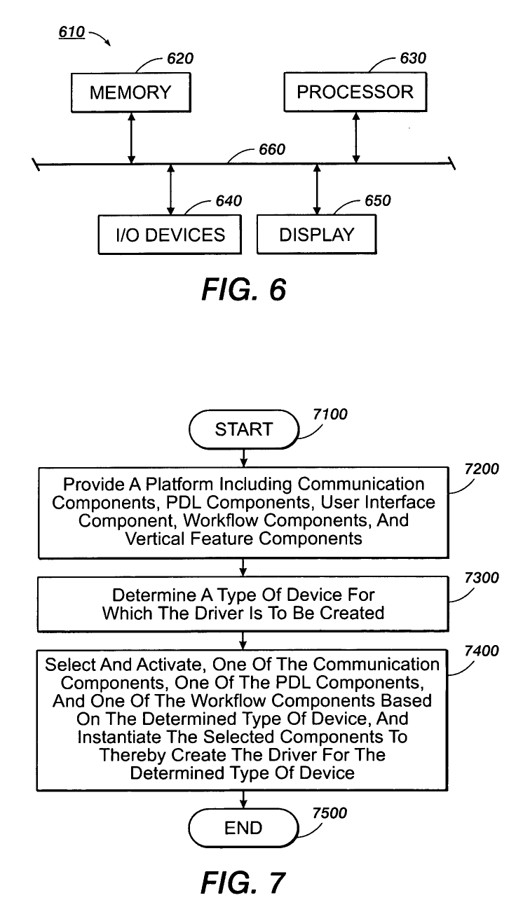

FIG. 6 illustrates a diagram of a system 610. The system 610 may be embodied within devices such as a desktop computer, a laptop computer, a handheld computer, a handheld communication device, or another type of computing device, or the like. The system 610 may include a memory 620, a processor 630, input/output devices 640, a display 650 and a bus 660. The bus 660 may permit communication and transfer of signals among the components of the computing device 610.

Processor 630 may include at least one conventional processor or microprocessor that interprets and executes instructions. The processor 630 may be a general purpose processor or a special purpose integrated circuit, such as an ASIC, and may include more than one processor section. Additionally, the system 610 may include a plurality of processors 630.

Memory 620 may be a random access memory (RAM) or another type of dynamic storage device that stores information and instructions for execution by processor 630. Memory 620 may also include a read-only memory (ROM) which may include a conventional ROM device or another type of static storage device that stores static information and instructions for processor 630. The memory 620 may be any memory device that stores data for use by system 610.

Input/output devices 640 (I/O devices) may include one or more conventional input mechanisms that permit a user to input information to the system 610, such as a microphone, touchpad, keypad, keyboard, mouse, pen, stylus, voice recognition device, buttons, and the like, and output mechanisms such as one or more conventional mechanisms that output information to the user, including a display, one or more speakers, a storage medium, such as a memory, magnetic or optical disk, disk drive, a printer device, and the like, and/or interfaces for the above. The display 650 may typically be an LCD or CRT display as used on many conventional computing devices, or any other type of display device.

The system 610 may perform functions in response to processor 130 by executing sequences of instructions or instruction sets contained in a computer-readable medium, such as, for example, memory 620. Such instructions may be read into memory 620 from another computer-readable medium, such as a storage device, or from a separate device via a communication interface, or may be downloaded from an external source such as the Internet. The system 610 may be a stand-alone system, such as a personal computer, or may be connected to a network such as an intranet, the Internet, and the like. Other elements may be included with the system 610 as needed.

The memory 620 may store instructions that may be executed by the processor to perform various functions. For example, the memory may store printer driver instructions to allow the system to perform various printing functions in association with a particular printer connected to the system. The printer driver instructions are typically unique to each specific type of printer, and the system 610 may store a plurality of print drivers each for a different printer.

FIG. 7 illustrates a flowchart of a method of creating drivers for use in a network. The method starts at 7100. At 7200, a platform is provided, the platform including: 1) a plurality of selectable communication components, each communication component relating to a type of network communication associated with a type of device; 2) a plurality of selectable PDL components, each PDL component relating to a type of PDL associated with a type of device; 3) a user interface component, the user interface component having plurality of selectable user interface elements; 4) a plurality of selectable workflow components, each workflow component relating to a type of workflow to be associated with a device; and 5) a plurality of selectable vertical feature components.

At 7300, a type of the device for which the driver is to be created is determined, the device being on the network. At 7400, based on the determined type of the device, one of the communication components, one of the PDL components, the user interface component, and one of the workflow components are selected and activated, and each of the selected components are instantiated, thereby creating a driver suitable for the determined type of device on the network.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein. The various elements of platform 10 shown in FIG. 1 may be considered as program modules, for example.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method of creating drivers for use in a network, the network including computers and devices, each of the drivers created for one of the devices, comprising:
providing a platform, the platform including: 1) a plurality of selectable communication components, each communication component relating to a type of network communication associated with a type of device; 2) a plurality of selectable PDL components, each PDL component relating to a type of PDL associated with a type of device; 3) a user interface component, the user interface component having plurality of selectable user interface elements; 4) a plurality of selectable workflow components, each workflow component relating to a type of workflow to be associated with a device; and 5) a plurality of selectable vertical feature components;
determining a type of the device for which the driver is to be created, the device being on the network; and
based on the determined type of the device, selecting and activating one of the communication components, one of the PDL components, the user interface component, and one of the workflow components, and instantiating each of the selected components, thereby creating a driver suitable for the determined type of device on the network.

2. The method of claim 1, wherein the one of the communication components is selected further based on a type of communication employed by the device.

3. The method of claim 1, wherein the one of the PDL components is selected further based on a PDL language used by the device.

4. The method of claim 1, wherein the one of the workflow components is further selected based on a desired type of workflow to be associated with the device.

5. The method of claim 1, further comprising determining device capabilities, device options, and device constraints for the device.

6. The method of claim 5, further comprising selecting ones of the user interface elements based on the determined device capabilities, device options, and device constraints for the device.

7. The method of claim 6, wherein the created driver includes a user interface, and the user interface includes features based on the determined user interface elements.

8. The method of claim 1, wherein each vertical feature component includes a feature hierarchy including code relating directly to a user interface for the feature and an associated execution code.

9. An apparatus for creating a driver for use in a network, the network including computers and devices, comprising:
a memory that stores instructions for creating the driver;
a processor that executes the instructions to cause creation of the driver by:
providing a platform, the platform including: 1) a plurality of selectable communication components, each communication component relating to a type of network communication associated with a type of device; 2) a plurality of selectable PDL components, each PDL component relating to a type of PDL associated with a type of device; 3) a user interface component, the user interface component having plurality of selectable user interface elements; 4) a plurality of selectable workflow components, each workflow component relating to a type of workflow to be associated with a device; and 5) a plurality of selectable vertical feature components;
determining a type of the device for which the driver is to be created, the device being on the network; and
based on the determined type of the device, selecting and activating one of the communication components, one of the PDL components, the user interface component, and one of the workflow components, and instantiating each of the selected components, thereby creating a driver suitable for the determined type of device on the network.

10. The apparatus of claim 9, wherein the one of the communication components is selected further based on a type of communication employed by the device.

11. The apparatus of claim 9, wherein the one of the PDL components is selected further based on a PDL language used by the device.

12. The apparatus of claim 9, wherein the one of the workflow components is further selected based on a desired type of workflow to be associated with the device.

13. The apparatus of claim 9, wherein the instructions further comprise instructions for determining device capabilities, device options, and device constraints for the device.

14. The apparatus of claim 13, wherein the instructions further comprise instructions for selecting ones of the user interface elements based on the determined device capabilities, device options, and device constraints for the device.

15. The apparatus of claim 14, wherein the created driver includes a user interface, and the user interface includes features based on the determined user interface elements.

16. The apparatus of claim 9, wherein each vertical feature component includes a feature hierarchy including code relating directly to a user interface for the feature and an associated execution code.

17. A computer-readable medium, comprising:
a computer-usable data carrier storing instructions, the instructions when executed by a computer causing the computer to create a driver for use in a network, the network including computers and devices, by:
providing a platform, the platform including: 1) a plurality of selectable communication components, each communication component relating to a type of network communication associated with a type of device; 2) a plurality of selectable PDL components, each PDL component relating to a type of PDL associated with a type of device; 3) a user interface component, the user interface component having plurality of selectable user interface elements; 4) a plurality of selectable workflow components, each workflow component relating to a type of workflow to be associated with a device; and 5) a plurality of selectable vertical feature components;
determining a type of the device for which the driver is to be created, the device being on the network; and
based on the determined type of the device, selecting and activating one of the communication components, one of the PDL components, the user interface component, and one of the workflow components, and instantiating each of the selected components, thereby creating a driver suitable for the determined type of device on the network.

18. The computer-readable medium of claim 17, wherein the one of the communication components is selected further based on a type of communication employed by the device.

19. The computer-readable medium of claim 17, wherein the one of the PDL components is selected further based on a PDL language used by the device.

20. The computer-readable medium of claim 17, wherein the one of the workflow components is further selected based on a desired type of workflow to be associated with the device.

21. The computer-readable medium of claim 17, wherein the instructions further comprise instructions for determining device capabilities, device options, and device constraints for the device.

22. The computer-readable medium of claim 21, wherein the instructions further comprise instructions for selecting ones of the user interface elements based on the determined device capabilities, device options, and device constraints for the device.

23. The computer-readable medium of claim 22, wherein the created driver includes a user interface, and the user interface includes features based on the determined user interface elements.

24. The computer-readable medium of claim 17, wherein each vertical feature component includes a feature hierarchy including code relating directly to a user interface for the feature and an associated execution code.
